(19) United States
(12) Patent Application Publication
(10) Pub. No.: US 2011/0263268 A1
(43) Pub. Date: Oct. 27, 2011

(54) NAVIGATION APPARATUS, LOCATION DETERMINATION SYSTEM AND METHOD OF LOCATION DETERMINATION

(75) Inventor: Victor Shcherbatyuk, Turnhout (BE)

(73) Assignee: TOM TOM INTERNATIONAL B.V., Amsterdam (NL)

(21) Appl. No.: 12/736,861

(22) PCT Filed: Jan. 14, 2009
(86) PCT No.: PCT/EP2009/050356

§ 371 Date: Apr. 7, 2011

(51) Int. Cl. H04W 24/00

(52) U.S. Cl. 455/456.1

(57) ABSTRACT

A navigation apparatus includes a wireless communications unit for data communication via a wireless communications network supported by identifiable base stations. The apparatus also includes a processing resource arranged to support, when in use, an operational environment, the operational environment supporting a location determination module arranged to receive at a current location at least identities of a number of the identifiable base stations receivable from the wireless communications unit. In at least one embodiment, the location determination module is capable of accessing a data store including a plurality of data association entries. Each data association entry includes a stored number of identities of the identifiable base stations and a location identifier associated with a location where the stored number of identities is receivable. The location determination module is also arranged to determine from the plurality of data association entries the current location associated with the stored number of identities.

### FIELD OF THE INVENTION

The present invention relates to a navigation apparatus of the type that, for example, is capable of receiving a communications signal from a base station of a communications network. The present invention also relates to a location determination system of the type that, for example, comprises a navigation apparatus capable of receiving a communications signal from a base station of a communications network. The present invention further relates to a method of location determination, the method being of the type that, for example, receives a communications signal from a base station of a communications network.

### BACKGROUND TO THE INVENTION

Portable computing devices, for example Portable Navigation Devices (PNDs) that include GPS (Global Positioning System) signal reception and processing functionality are well known and are widely employed as in-car or other vehicle navigation systems.

In general terms, a modern PND comprises a processor, memory and map data stored within said memory. The processor and memory cooperate to provide an execution environment in which a software operating system is typically established, and additionally it is commonplace for one or more additional software programs to be provided to enable the functionality of the PND to be controlled, and to provide various other functions.

Typically, these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but can be on a steering wheel if the device is built into a vehicle), and a microphone for detecting user speech. In one particular arrangement, the output interface display may be configured as a touch sensitive display (by means of a touch sensitive overlay or otherwise) additionally to provide an input interface by means of which a user can operate the device by touch.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Bluetooth, Wi-Fi, Wi-Max, GSM, UMTS and the like. PNDs of this type also include a GPS antenna by means of which satellite-broadcast signals, including location data, can be received and subsequently processed to determine a current location of the device.

The PND may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically, such features are most commonly provided in in-vehicle navigation systems, but may also be provided in PNDs if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads).

The device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking), are being used to identify traffic delays and to feed the information into notification systems.

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant), a media player, a mobile telephone or the like, and in these cases, the normal functionality of the hand-held system is extended by means of the installation of software on the device to perform both route calculation and navigation along a calculated route.

Once a route has been calculated, the user of the PND interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated, a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

As mentioned above, it is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above, for example the GO 930 Traffic model manufactured and supplied by TomTom International B.V., provide a reliable means for enabling users to navigate from one position to another. Such devices are of great utility when the user is not familiar with the route to the destination to which they are navigating.

As indicated above, PNDs use GPS satellite-broadcast signals in order to determine the current location of the PND. However, in some circumstances, quality of the satellite-broadcast signals is poor, thereby rendering the PND unable to determine the current location. Similarly, in some circumstances, the PND may be unable to receive any satellite-broadcast signals, or satellite-broadcast signals from a sufficient number of satellites in order to be able to determine the current location.

In a so-called “cold start” situation, namely when the PND is first powered-up after a period of non-use, the PND needs to know the location of at least three earth-orbiting satellites, preferably four satellites, in order to be able to determine the current location. In this respect, signal quality may be at least adequate, but at start-up, the PND also has initially to predict the locations of the 4 satellites. Whilst a sophisticated set of algorithms is typically used to calculate the locations of the satellites, the calculation has an associated time delay and it is usually desirable to minimise this time delay so that the user is not inconvenienced.

One known solution is to download a data file containing up-to-date ephemeris data, but on occasions access to this data is not always possible, for example when a General Packet Radio Service (GPRS) or other data service is unavailable to the PND whilst it is being used in a mobile capacity, such as in a vehicle. It is therefore desirable to find an alternative mechanism for determining the current location, at least during cold-start situations, but also at locations where location determination cannot be achieved through receipt and processing of satellite-broadcast signals.

### SUMMARY OF THE INVENTION

According to a first aspect of the present invention, there is provided a navigation apparatus comprising: a wireless communications unit for data communication via a wireless communications network supported by identifiable base stations; a processing resource arranged to support, when in use, an operational environment, the operational environment supporting a location determination module arranged to receive from the wireless communications unit and at a current location at least identities of a number of the identifiable base stations receivable by the wireless communications unit; wherein the location determination module is capable of accessing a data store comprising a plurality of data association entries, each data association entry comprising a stored number of identities of the identifiable base stations and a location identifier associated with a location where the stored number of identities are receivable; and the location determination module is arranged to determine from the plurality of data association entries the current location associated with the stored number of identities.

The apparatus may further comprise: a location-determination signal receiver; wherein the operational environment may support another location determination module capable of determining the current location based upon wireless location-determination signals when received by the location determination signal receiver.

The location determination module may be arranged to attempt to match the identities of the number of the identifiable base stations respectively with the stored number of identities of the identifiable base stations of a data association entry of the plurality of data association entries; the location identifier may be associated with the stored number of identities of the identifiable base stations also substantially identifying the current location when the match occurs.

The match may be a best match.

The location determination module may be arranged to measure a respective degree of match in respect of each of a number of the plurality of data association entries by calculating a respective score in respect of match between the identities of the number of identifiable base stations and the stored number of identities of the identifiable base stations of the each of the number of the plurality of data association entries.

For each of the number of the plurality of data association entries, the respective score may be indicative of a quantity of matching identities of the receivable number of identities with the corresponding stored number of identities of the identifiable base stations.

The location determination module may be arranged also to receive from the wireless communications unit a number of signal strength measurements in respect of the current location and respectively associated with the receivable number of identities.

The each data association entry may also comprise a number of signal strength ranges respectively associated with the stored number of identities of the identifiable base stations.

The location determination module may be arranged to attempt to find a match by finding a data association entry of the plurality of data association entries having as many as possible of the number of signal strength ranges thereof bounding respective signal strength measurements of the number of signal strength measurements.

More than one of the plurality of data association entries may constitute best matches in respect of the number of signal strength measurements.

The location determination module may be arranged to calculate the current location from the location identifiers of the more than one data association entries. The location determination module may be arranged to calculate a substantially average location from locations associated with the location identifiers.

The match may be a best match.

The location determination module may be arranged to measure a respective degree of match in respect of the data association entry by calculating a score in respect of the number of signal strength ranges bounding the respective signal strength measurements of the number of signal strength measurements; a respective score may be calculated for each of the plurality of data association entries.

A highest score may be indicative of the best match; the location determination module may be arranged to find the highest score.

The wireless communications network may be a cellular communications network.

The wireless communications network may be a Global System for Mobile communications (GSM) network. Alternatively, the wireless communications network may be a Universal Mobile Telecommunications System (UMTS) network.

The at least identities may be at least cell identities (IDs) respectively associated with the number of the identifiable base stations.

According to a second aspect of the present invention, there is provided a location determination system comprising: a navigation apparatus as claimed in any one of the preceding claims; a server apparatus comprising the data store; wherein the navigation apparatus is arranged to send a request to the server apparatus in order to access the plurality of data association entries.

According to a third aspect of the present invention, there is provided a method of location determination, the method comprising: receiving from a wireless communications and at a current location at least identities of a number of the identifiable base stations receivable by the wireless communications unit; accessing a data store comprising a plurality of data association entries, each data association entry comprising a stored number of identities of the identifiable base stations and a location identifier associated with a location where the stored number of identities are receivable; and determining from the plurality of data association entries the current location associated with the stored number of identities.

According to a fourth aspect of the present invention, there is provided a method of navigation in the absence of sufficient satellite-broadcast location-related information comprising the method as set forth above in relation to the third aspect of the invention.

According to a fifth aspect of the present invention, there is provided a computer program element comprising computer program code means to make a computer execute the method as set forth above in relation to the third or fourth aspects of the invention.

The computer program element may be embodied on a computer readable medium.

Advantages of these embodiments are set out hereafter, and further details and features of each of these embodiments are defined in the accompanying dependent claims and elsewhere in the following detailed description.

It is thus possible to provide a navigation apparatus, a location determination system and a method of location determination that is capable of determining a current location in the absence of an ability by the navigation apparatus to determine or determine sufficiently quickly the current location by GPS or other satellite-broadcast signal technique. The method, system and apparatus therefore reduce inconvenience to a user, thereby providing an improved user experience in relation to navigation, as well as the possibility of saving the user time. Hence, in cold-start situations, the navigation apparatus has an improved starting time from being powered-up, and where satellite-broadcast signals are of insufficient quality and/or unavailable in sufficient quantity, an opportunity to determine the current location still exists.

### BRIEF DESCRIPTION OF THE DRAWINGS

At least one embodiment of the invention will now be described, by way of example only, with reference to the accompanying drawings, in which:

FIG. 1 is a schematic illustration of an exemplary part of a Global Positioning System (GPS) usable by a navigation apparatus;

FIG. 2 is a schematic diagram of a navigation system and/or data collection system supporting communication between a navigation apparatus and a server apparatus;

FIG. 3 is a schematic illustration of electronic components of the navigation apparatus of FIG. 2 or any other suitable navigation apparatus;

FIG. 4 is a schematic diagram of a Global System for Mobile communication (GSM) communications module of the navigation apparatus of FIG. 2;

FIG. 5 is a schematic representation of an architectural stack employed by the navigation apparatus of FIG. 3;

FIG. 6 is a schematic diagram of a part of a communications network in which the navigation apparatus of FIG. 3 is located;

FIG. 7 is a flow diagram of a method of collecting location-related information for subsequent use;

FIGS. 8a and 8b are schematic diagrams of possible data structures employed in relation to recordal of location-related information;

FIG. 9 is a flow diagram of a method of processing location-related information for subsequent use;

FIG. 10 is a flow diagram of a method of location determination constituting another embodiment of the invention;

FIG. 11 is a flow diagram of a method of scoring used in the method of FIG. 10; and

FIG. 12 is a flow diagram of a method of location determination constituting yet another embodiment of the invention.

### DETAILED DESCRIPTION OF PREFERRED EMBODIMENTS

Throughout the following description identical reference numerals will be used to identify like parts.

One or more embodiments of the present invention will now be described with particular reference to a PND. It should be remembered, however, that the teachings herein are not limited to PNDs but are instead universally applicable to any type of processing device, for example but not essentially those configured to execute navigation software in a portable and/or mobile manner so as to provide route planning and navigation functionality. It follows therefore that in the context of the embodiments set forth herein, a navigation apparatus is intended to include (without limitation) any type of route planning and navigation apparatus, irrespective of whether that device is embodied as a PND, a vehicle such as an automobile, or indeed a portable computing resource, for example a portable personal computer (PC), a mobile telephone or a Personal Digital Assistant (PDA) executing, for example, route planning and navigation software. Indeed, a mobile telephone, smartphone or the like can simply be employed in respect of some embodiments without the benefit of route planning or navigation software.

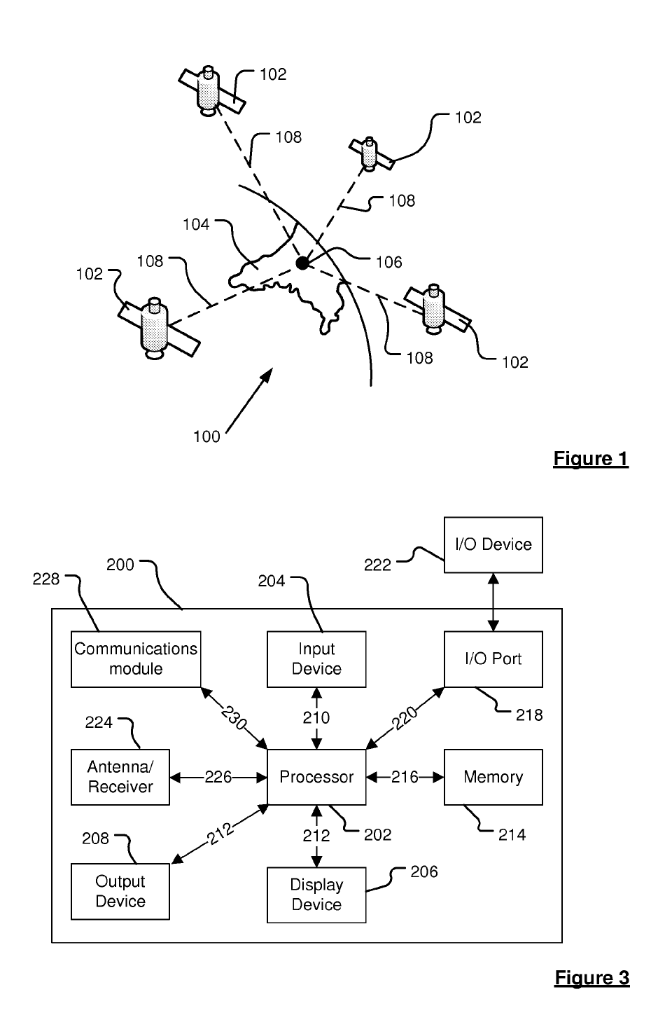

With the above provisos in mind, the Global Positioning System (GPS) of FIG. 1 and the like are used for a variety of purposes. In general, the GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal allows the receiving device to calculate its three dimensional position by the same geometrical calculation in a known manner. The position and velocity data can be updated in real time on a continuous basis by an unlimited number of users.

As shown in FIG. 1, the GPS system 100 comprises a plurality of satellites 102 orbiting about the earth 104. A GPS receiver 106 receives spread spectrum GPS satellite data signals 108 from a number of the plurality of satellites 102. The spread spectrum data signals 108 are continuously transmitted from each satellite 102, the spread spectrum data signals 108 transmitted each comprise a data stream including information identifying a particular satellite 102 from which the data stream originates. The GPS receiver 106 generally requires spread spectrum data signals 108 from at least three satellites 102 in order to be able to calculate a two-dimensional position. Receipt of a fourth spread spectrum data signal enables the GPS receiver 106 to calculate, using a known technique, a three-dimensional position.

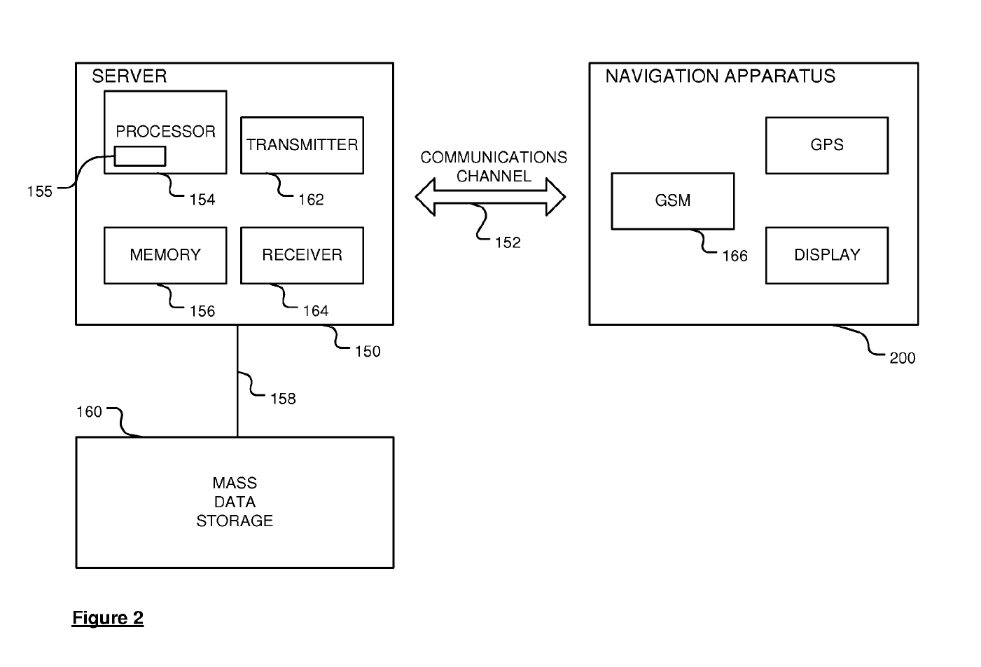

In FIG. 2, a location data processing and determination system comprises a navigation apparatus 200 capable of communicating, if desired in an embodiment, with a server 150 via a communications channel 152 supported by a communications network that can be implemented by any of a number of different arrangements. The communication channel 152 generically represents the propagating medium or path that connects the navigation apparatus 200 and the server 150. The server 150 and the navigation apparatus 200 can communicate when a connection via the communications channel 152 is established between the server 150 and the navigation apparatus 200 (noting that such a connection can be a data connection via mobile device, a direct connection via personal computer (not shown) via the internet, etc.).

The communication channel 152 is not limited to a particular communication technology. Additionally, the communication channel 152 is not limited to a single communication technology; that is, the channel 152 may include several communication links that use a variety of technology. For example, the communication channel 152 can be adapted to provide a path for electrical, optical, and/or electromagnetic communications signals, etc. As such, the communication channel 152 includes, but is not limited to, one or a combination of the following: electric circuits, electrical conductors such as wires and coaxial cables, fibre optic cables, converters, radio-frequency (RF) waves, the atmosphere, free space, etc. Furthermore, the communication channel 152 can include intermediate devices such as routers, repeaters, buffers, transmitters, and receivers, for example.

In one illustrative arrangement, the communication channel 152 is supported by telephone and computer networks. Furthermore, the communication channel 152 may be capable of accommodating wireless communication, for example, infrared communications, radio frequency communications, such as microwave frequency communications, etc. Additionally, the communication channel 152 can accommodate satellite communication if required.

The communication signals transmitted through the communication channel 152 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 152. These signals may be modulated, encrypted and/or compressed signals as may be desirable for the communication technology.

In this example, the navigation apparatus 200 comprises mobile telephone technology, including an antenna, for example, or optionally using an internal antenna of the navigation apparatus 200. The mobile telephone technology within the navigation apparatus 200 can also include an insertable card (e.g. Subscriber Identity Module (SIM) card). As such, mobile telephone technology within the navigation apparatus 200 can establish a network connection between the navigation apparatus 200 and the server 150, via the Internet for example, in a manner similar to that of any wireless communications-enabled terminal. Further details of the mobile telephone technology will be described later herein.

As explained above, the establishing of the network connection between the navigation apparatus 200 (via a service provider) and another device such as the server 150, using the Internet for example, can be done in any suitable known manner. In this respect, any number of appropriate data communications protocols can be employed, for example the TCP/IP layered protocol. Furthermore, the mobile device can utilize any number of communication standards such as CDMA2000, GSM, IEEE 802.11 a/b/c/g/n, etc. However, in the present example, the navigation apparatus 200 is configured to operate in a GSM network, the GSM network being an example of a cellular communications network.

The server 150 includes, in addition to other components which may not be illustrated, a processor 154 constituting a processing resource and operatively connected to a memory 156 and further operatively connected, via a wired or wireless connection 158, to a mass data storage device 160. The mass storage device 160 contains a store of, inter alia, data association entities. Further details of such data are set out later below. The mass storage device 160 can be a separate device from the server 150 or can be incorporated into the server 150. The processor 154 is further operatively connected to transmitter 162 and receiver 164, to transmit and receive information to and from the navigation apparatus 200 via the communications channel 152. The signals sent and received may include data, communication, and/or other propagated signals. The transmitter 162 and receiver 164 may be selected or designed according to the communications requirement and communication technology used in the communication design for the navigation system. Further, it should be noted that the functions of transmitter 162 and receiver 164 may be combined into a single transceiver.

As mentioned above, the navigation apparatus 200 can be arranged to communicate with the server 150 through communications channel 152, using the mobile telephone technology 166 to send and receive data through the communications channel 152, noting that the mobile telephone technology can further be used to communicate with devices other than the server 150. Further, the mobile telephone technology 166 is selected or designed according to communication requirements and communication technology used in the communication design for the navigation system. Of course, the navigation apparatus 200 comprises other hardware and/or functional parts, which will be described later herein in further detail.

Software stored in server memory 156 provides instructions for the processor 154 and allows the server 150 to provide a location determination service to the navigation apparatus 200 and/or perform a location data processing task. For example, the server apparatus 150 can provide a service involving processing requests for data association entry updates from the navigation apparatus 200 and transmitting the current data association entries from the mass data storage 160 to the navigation apparatus 200. Another service is the servicing of a request for location determination from the navigation apparatus 200. Also, the server 150 can process data association entries in a manner to be described later herein. These services need not be provided by the same server apparatus. However, for convenience of description, the server 150 is described herein as providing all such services.

In relation to the location determination service, the server 150 can be used as a remote source of processed location determination data accessible by the navigation apparatus 200 via, for example, a wireless channel. The server 150 may include a network server located on a local area network (LAN), wide area network (WAN), virtual private network (VPN), etc. Indeed, a Personal Computer (PC) can be connected between the navigation apparatus 200 and the server 150 to establish an Internet connection between the server 150 and the navigation apparatus 200.

The navigation apparatus 200 may be provided with information from the server 150 via information downloads, of the type mentioned above, which may be periodically updated automatically or upon a user connecting the navigation apparatus 200 to the server 150 and/or may be more dynamic upon a more constant or frequent wireless connection being made between the server 150 and navigation apparatus 200.

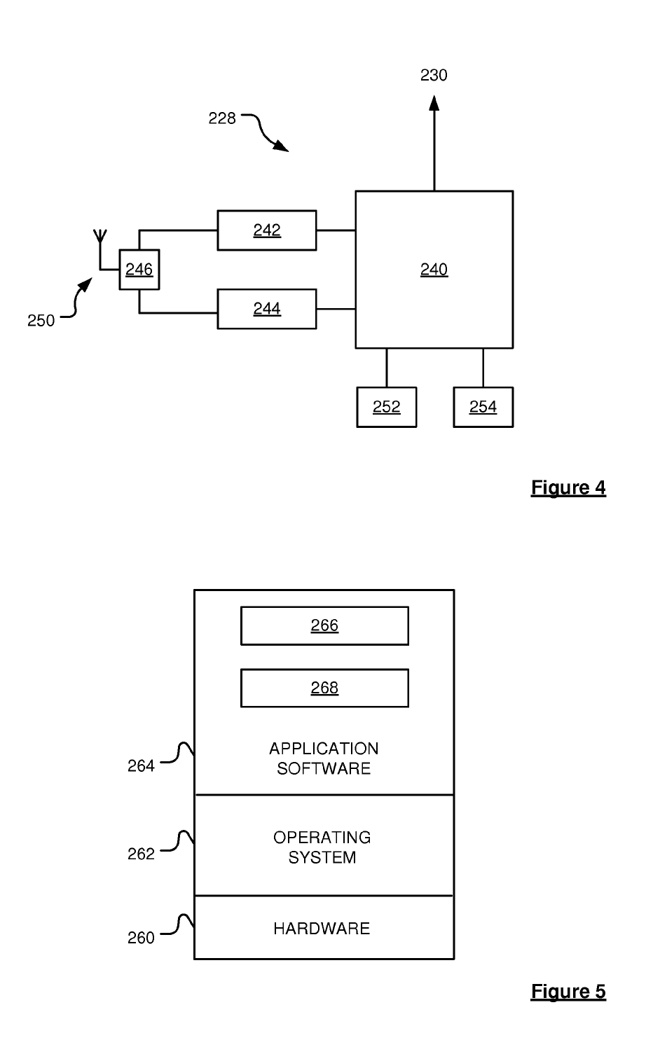

Referring to FIG. 3, it should be noted that the block diagram of the navigation apparatus 200 is not inclusive of all components of the navigation apparatus, but is only representative of many example components. The navigation apparatus 200 is located within a housing (not shown). The navigation apparatus 200 includes a processor 202, the processor 202 being coupled to an input device 204 and a display device, for example a display screen 206. Although reference is made here to the input device 204 in the singular, the skilled person should appreciate that the input device 204 represents any number of input devices, including a keyboard device, voice input device, touch panel and/or any other known input device utilised to input information. Likewise, the display screen 206 can include any type of display screen such as a Liquid Crystal Display (LCD), for example.

In one arrangement, one aspect of the input device 204, the touch panel, and the display screen 206 are integrated so as to provide an integrated input and display device, including a touchpad or touchscreen input to enable both input of information (via direct input, menu selection, etc.) and display of information through the touch panel screen so that a user need only touch a portion of the display screen 206 to select one of a plurality of display choices or to activate one of a plurality of virtual or “soft” buttons. In this respect, the processor 202 supports a Graphical User Interface (GUI) that operates in conjunction with the touchscreen.

In the navigation apparatus 200, the processor 202 is operatively connected to and capable of receiving input information from input device 204 via a connection 210, and operatively connected to at least one of the display screen 206 and an output device 208, via respective output connections 212, to output information thereto. The output device 208 is, for example, an audible output device (e.g. including a loudspeaker). As the output device 208 can produce audible information for a user of the navigation apparatus 200, it should equally be understood that input device 204 can include a microphone and software for receiving input voice commands as well. Further, the navigation apparatus 200 can also include any additional input device 204 and/or any additional output device, such as audio input/output devices for example. The processor 202 is operably coupled to a memory resource 214 via connection 216 and is further adapted to receive/send information from/to input/output (I/O) ports 218 via connection 220, wherein the I/O port 218 is connectible to an I/O device 222 external to the navigation apparatus 200. The memory resource 214 comprises, for example, a volatile memory, such as a Random Access Memory (RAM) and a non-volatile memory, for example a digital memory, such as a flash memory. The external I/O device 222 may include, but is not limited to an external listening device, such as an earpiece for example. The connection to I/O device 222 can further be a wired or wireless connection to any other external device such as a car stereo unit for hands-free operation and/or for voice activated operation for example, for connection to an earpiece or headphones.

FIG. 3 further illustrates an operative connection between the processor 202 and an antenna/receiver 224 via connection 226, wherein the antenna/receiver 224 constitutes a location-determination signal receiver and can be a GPS antenna/receiver for example. It should be understood that the antenna and receiver designated by reference numeral 224 are combined schematically for illustration, but that the antenna and receiver may be separately located components, and that the antenna may be a GPS patch antenna or helical antenna for example.

In order to provide communications capability in the GSM network mentioned above, the navigation apparatus 200 also comprises a GSM communications module 228 interfaced with the processing resource 202 and coupled thereto by connection 230. Referring to FIG. 4, the GSM communications module 228 comprises another processing resource 240, the another processing resource 240 being, in this example, a chipset of a cellular communications terminal. The another processing resource 240 is coupled to a transmitter chain 242 and a receiver chain 244, the transmitter and receiver chains 242, 244 being coupled to a duplexing filter 246. The duplexing filter 246 is coupled to an antenna 250.

The GSM communications module 228 also possesses an on-board volatile memory, for example a RAM 252, and an on-board non-volatile memory, for example a ROM 254, each coupled to the another processing resource 240. The skilled person should appreciate that the architecture of the GSM communications module 240 described above comprises other elements, for example a SIM module, but such additional elements have not been described herein for the sake of preserving conciseness and clarity of description. The another processing resource 240 is configured to permit communication, in this example, of Base Transceiver (BTS) identities and signal strength measurements in respect of the BTS identities to the processing resource 202 of the navigation apparatus 200.

It will, of course, be understood by one of ordinary skill in the art that the electronic components shown in FIG. 3 are powered by one or more power sources (not shown) in a conventional manner. As will be understood by one of ordinary skill in the art, different configurations of the components shown in FIG. 3 are contemplated. For example, the components shown in FIG. 3 may be in communication with one another via wired and/or wireless connections and the like. Thus, the navigation apparatus 200 described herein can be a portable or handheld navigation apparatus 200.

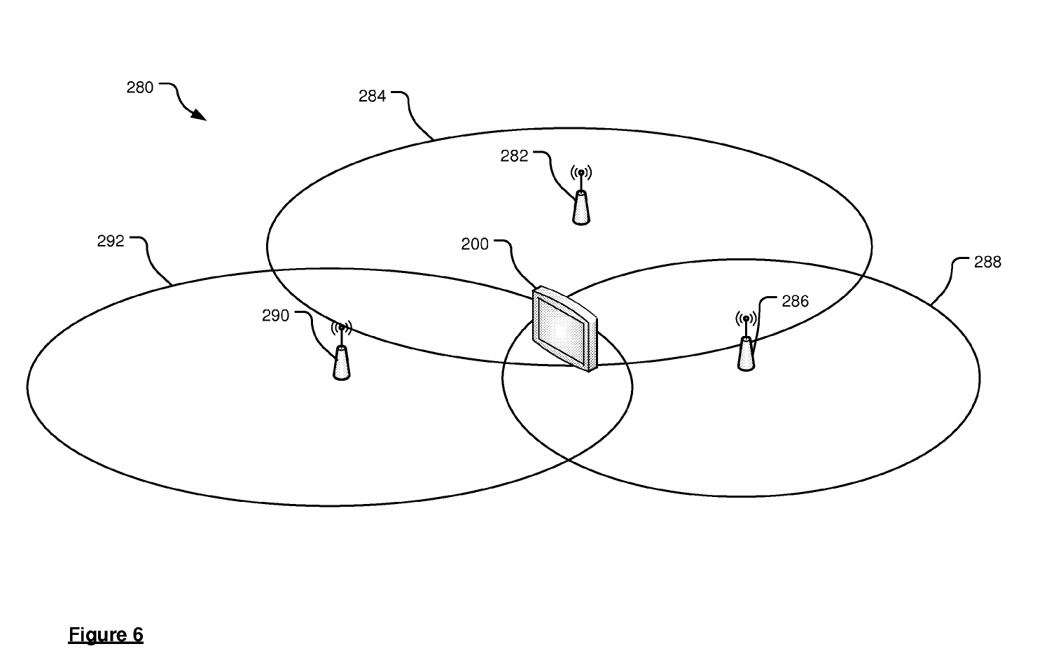

Turning to FIG. 5, the memory resource 214 stores a boot loader program (not shown) that is executed by the processor 202 in order to load an operating system 262 from the memory resource 214 for execution by functional hardware components 260, which provides an environment in which application software 264 can run. The operating system 262 serves to control the functional hardware components 260 and resides between the application software 264 and the functional hardware components 260. The application software 264 provides an operational environment including the GUI that supports core functions of the navigation device 200, for example map viewing, route planning, navigation functions and any other functions associated therewith. Part of the application software 264 comprises a data logger module 266 and a BTS-based location determination module 268.

Referring to FIG. 6, a portion of the GSM network 280 comprises a first BTS 282 that supports a first communications cell 284, a second BTS 286 that supports a second communications cell 288 and a third BTS 290 that supports a third communications cell 292. In this example, and at an exemplary instance in time, the navigation apparatus 200 is located between the first, second and third BTSs 282, 286, 290 such that the navigation apparatus 200 resides in the first, second and third communications cells 284, 288, 292.

The GSM system in accordance with which the network 280 operates employs a Time Division Multiple Access (TDMA) scheme that supports eight full duplex signal paths per radio-frequency channel. In the GSM network 280, a single, primary, radio channel is assigned to each of the first, second and third BTSs 282, 286, 290.

Typically, a so-called Common Control CHannel (CCCH) of the GSM system is used to exchange paging and setup control information. Distinctive identification signals, synchronization and timing information is also transmitted by each BTS on the CCCH in order to, inter alia, allow a Mobile Subscriber (MS) to differentiate between primary and non-primary channels.

Upon powering-up the navigation apparatus 200, the GSM communications module 228 scans a pre-programmed spectrum in search of CCCH identification signals transmitted from nearby, i.e. receivable, BTSs. Upon detecting a CCCH identification signal, the GSM communication module 228 measures a signal quality factor, for example signal strength, of the CCCH identification signal.

Upon completing the scan of frequencies within the spectrum, the MS, in this example the GSM communications module 228, generally selects the BTS providing the largest relative signal quality factor as a serving BTS. Upon identifying, and locking onto a suitably strong signal, the GSM communication module 228 monitors the selected CCCH for incoming calls. While monitoring the serving BTS, the MS receives an adjacent base site frequency list on the CCCH of the serving BTS. Monitoring of primary channels of nearby receivable BTSs by measuring a so-called Received Signal Strength Indication (RSSI) in respect of each primary channel enables the GSM module 228 to be continually aware of other nearby BTSs. If desired, a frequency list communicated to the GSM module 228 by a serving BTS can be used to assist the GSM module 228 in monitoring nearby BTSs. Indeed, since the frequency list provided by a given BTS can be selective, the GSM communications module 228 can be configured to scan for other BTSs independently.

Operation of the navigation apparatus 200 will now be described in the context of collection of location-related data for subsequent use, for example after processing, by the navigation apparatus 200 in the absence of an ability to calculate a current location from satellite-broadcast signals, such as those received in relation to the GPS.

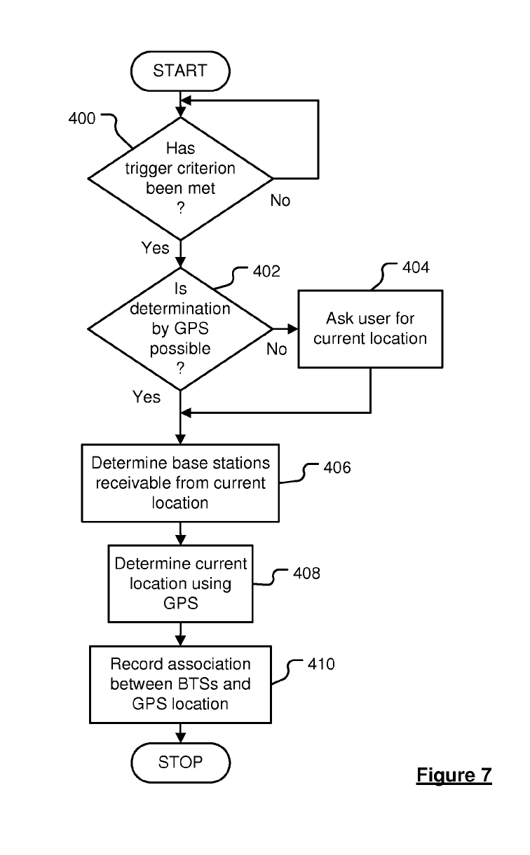

Referring to FIG. 7, the navigation apparatus 200 is assumed to be powered-up and travelling. In order to ensure consistent behaviour, the data logger module 266 employs a predetermined criterion. The predetermined criterion can be a predetermined period of time and/or a predetermined distance moved by the navigation apparatus 200, for example, every 3 metres. The predetermined criterion is used to decide when to make the following measurements. In this respect, the data logger module 266 firstly determines (Step 400) whether the predetermined trigger criterion has been met and waits until the trigger criterion has been met.

Assuming in this example that the navigation apparatus 200 is moving towards the relative position of FIG. 6 with respect to the three BTSs 282, 286, 290, once the trigger criterion has been met, for example the navigation apparatus 200 has translated at least 3 metres in any direction, the navigation apparatus 200 determines (Step 402) whether the GSM module 228 is able to provide identities of nearby BTSs, for example the identities (IDs) of the first, second and third BTSs 282, 286, 290. In the event that the navigation apparatus 200 is unable to determine the current location using the GPS capabilities thereof, the navigation apparatus 200 can, via the user interface, optionally interrogate (Step 404) the user in order to ascertain the current location. Of course, such interrogation of the user has to be minimised in order to avoid becoming an irritation to the user.

Thereafter, in a basic embodiment, the data logger module 266, using the capabilities of the GSM communications module 228, determines (Step 406) the identities of the nearby BTSs in the manner already described above. However, in a more sophisticated embodiment, the data logger module 266 also acquires signal strength measurements in respect of each of the nearby BTSs. Consequently, in the present example, the data logger module 228 is able to acquire from the GSM communications module 228 first, second and third signal strength measurements associated with the first, second and third BTSs 282, 286, 290, respectively.

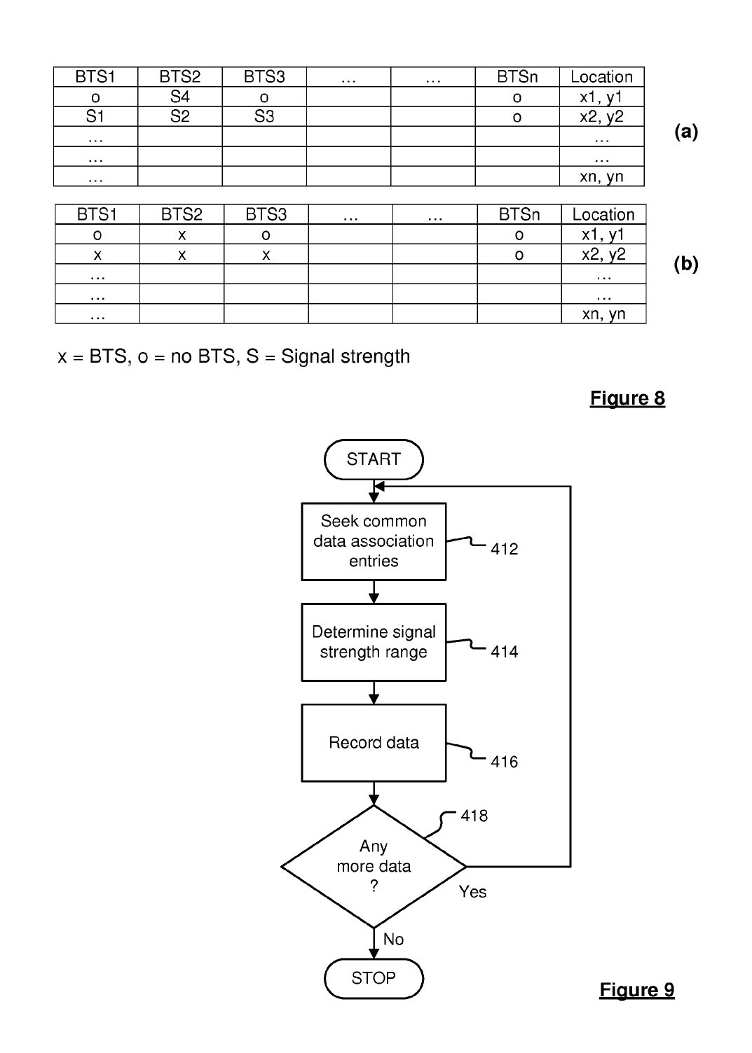

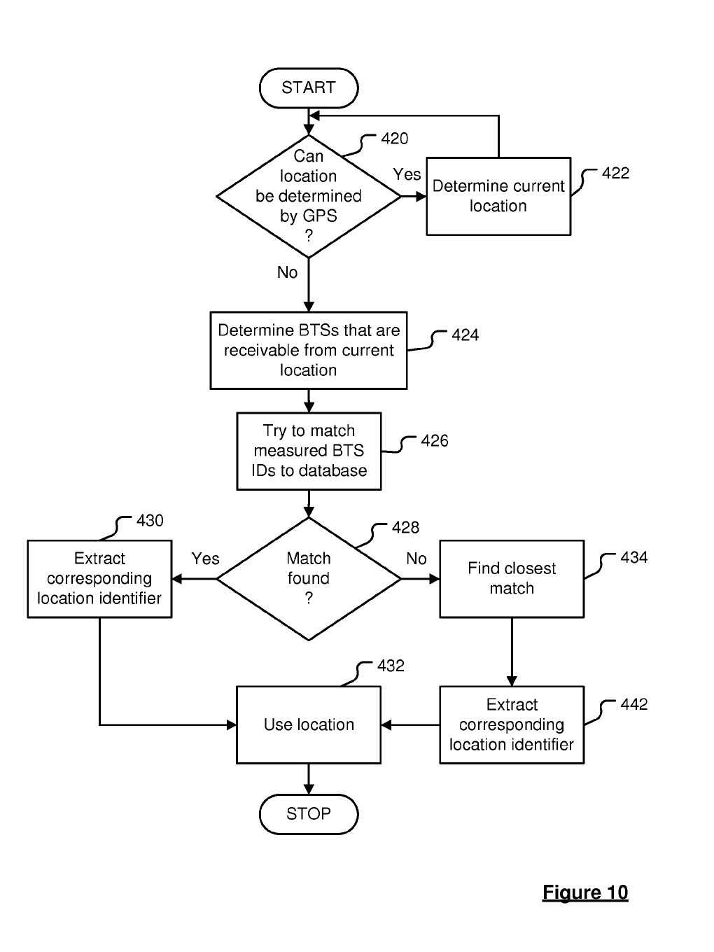

The navigation apparatus 200 then, using the GPS capabilities thereof, determines (Step 408) a current location of the navigation apparatus 200 and records (Step 410), in a table (FIG. 8a) of signals strength data and location data, the first, second and third signal strengths measured, identifying the respective BTSs, and the location determined above using the GPS capabilities of the navigation apparatus 200. Hence, an association is recorded between BTSs and locations. In the basic embodiment, the association is simply between identities of BTSs that are receivable at the current location by the GSM communications module 228 and the current location as measured by the navigation apparatus 200 (FIG. 8b). However, in the more sophisticated embodiment, the association is between identified BTS signal strength measurements of the GSM module 228 and the current location as determined by the navigation apparatus 200 using the GPS capabilities thereof.

As can be seen from FIGS. 8 (a) and (b), a record can be build up over time of current locations and information relating to BTSs that can be received by the navigation apparatus 200 at the current locations, respectively. Each entry constitutes a data association entry.

Operation of the above server apparatus 150 will now be described in the context of the data association entries having been generated by a population or community of navigation apparatus and communicated to the server apparatus 150 or another computing resource in order to create and/or supplement a database of raw BTS-based location data stored by the storage device 160. In this respect, each of the navigation apparatus in the population, for example the navigation apparatus 200, is configured with an ability to generate and send the data association entries as described above during a planned or unplanned journey of the navigation apparatus 200. The data association entries are recorded in a log, for example a log file, which is stored by the digital memory of the navigation apparatus 200. The log is communicated to the server apparatus 150 when a communications session is next established between the navigation apparatus 200 and the server apparatus 150, for example using the TomTom HOME system whereby the navigation apparatus 200 is docked with a Personal Computer (PC) or other computing device and the communications session is established via an Internet connection to which the PC is coupled. Data transfers can thus take place between the navigation apparatus 200 and the server 150. In this example, the content of the log file is stored in the BTS-based location database. The raw BTS-based location database thus comprises, inter alia, BTS identity data and location data. In this example, the location data is recorded as longitude and latitude coordinates. Of course, as the navigation apparatus 200 is suitably equipped to support wireless communications over a WAN in the present example, the navigation apparatus 200 can send periodic updates to the server apparatus 150 without having to wait to be docked with the PC.

In a first embodiment relating to processing of the raw data received from the navigation apparatus, in order to enhance the usability of the data stored in the raw BTS-based location database, a location data processing module 155 supported by the processor 154 analyses the data association entries of the raw BTS-based location database as follows. The location data processing module 155 simply analyses each data association entry of the raw BTS-based location database and identifies data association entries that identify the same BTSs in relation to a location area, for example 3 m² as identified by the associated longitude and latitude coordinates. The aggregated data is then stored in a BTS-coordinate database for subsequent publication and use by navigation apparatus.

In another embodiment (FIG. 9), where signal strength data has also been recorded in the BTS-based location database, the location data processing module 155 identifies (Step 412) from the plurality of data association entries, those data association entries comprising coordinate data residing in a predetermined first area, for example 3 m², defined by a first coordinate range. The location data processing module 155 then determines (Step 414), using data in respect of each BTS identified in relation to the first area, a range of signal strengths using the measured signal strengths for each BTS. For example, in the case of the first BTS 282 for longitude latitude coordinate range lo₁, la₁-lo₂, la₂, different signal strength measurements stored range from S₁-S₂. For the second BTS 286, for longitude latitude coordinate range lo₁, la₁-lo₂, la₂, different signal strength measurements stored range from S₃-S₄. For the third BTS 290, for longitude latitude coordinate range lo₁, la₁-lo₂, la₂, different signal strength measurements stored range from S₅-S₆. The ranges determined are then stored (Step 416) in the BTS-coordinate database along with coordinates corresponding to the centre of the first longitude-latitude coordinate range. Thereafter, the location data processing module 155 then determines if processing needs to take place in respect of other area ranges and if further processing is deemed necessary, the location data processing module 155 repeats the above process (Steps 412 to 418) in respect of another location area until processing in respect of all necessary location areas has been completed or no further data association entries remain to be processed.

After the above described processing, the database of BTS-coordinate data thus comprises associations between ranges of BTS signal strength measurements and coordinate mid-points.

Once the above data processing has been completed, the BTS-coordinate database can be published for use by navigation apparatus. In this respect, whilst the server 150 can be used to service requests for location determination, it is more prudent for the BTS-coordinate database to be stored locally by the memory resource 214 of the navigation apparatus 200 as the BTS-coordinate database is likely to be required when the GPRS functionality of the GSM network 280 is unavailable.

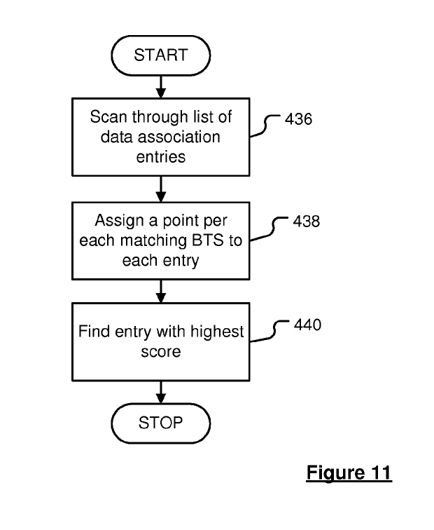

Referring to FIG. 10, when the navigation apparatus 200 is powered-up after a period of non-use, i.e. is in a cold-start condition, or the navigation apparatus 200 is already in a powered-up state, but unable to determine a current location using the GPS capabilities of the navigation apparatus 200, for example whilst providing navigation assistance, the current location can be determined in the following manner. In this respect, in a first embodiment of use of the BTS-coordinate database, it is assumed that the BTS-coordinate database only comprises associations between groups of identities of BTSs in the GSM network 280 and coordinate data, the groups of identities of BTSs comprise identities of a number of BTSs.

Initially, of course, the navigation apparatus 200 determines (Step 420) whether the current location can be determined by use of GPS capabilities and if this is possible, the navigation apparatus 200 determines (Step 422) the current location by GPS data, for example to be used in relation to navigation. In this respect, the application software 264 comprises another location determination module (not shown) capable of determining the current locations based upon wireless location-determination signals received by the antenna/receiver 224.

However, in the event that the navigation apparatus 200 is unable to determine the current location by GPS data, the BTS-based location determination module 268 of the navigation apparatus 200 determines (Step 424) the identities of a number of the BTSs in the GSM network 228 that are receivable from the current location. This information is acquired by the GSM communications module 228 in the manner already described above in relation to previous embodiments and so, for the sake of clarity and conciseness of description, will not be described further in relation to this embodiment.

The location determination module 268 then accesses the BTS-coordinate database in order to attempt to match the identities of the receivable BTSs at the current location with one of the stored number of identities of BTSs in the GSM network 228 associated with a location identifier where the BTSs associated with the stored number of identities of BTSs are known to be receivable. In this respect, the location determination module 268 attempts to find one of the data association entries in the BTS-coordinate database comprising and therefore identifying the same BTSs as those identified by the GSM communications module 228. For example, in the event the navigation apparatus 200 is located as shown in FIG. 6, where the first, second and third BTSs 282, 286, 290 are receivable from the current location, the data association entry in the BTS-coordinate database that needs to be found must identify the first, second and third BTSs 282, 286, 290, i.e. a BTS identity match is required.

The location determination module 268 therefore determines (Step 428) whether a match has been found. In the event that an exact match has been found, the location determination module 268 extracts (Step 430) the coordinate data constituting a location identifier from the data association entry found to be the exact match and uses (Step 432) the location identifier, in this example the location coordinates, as the current location that can be used, for example, for one or more navigation-related functions.

Hence, the location determination module 268 has determined the current location, which is associated with the stored number of BTS identities of the data association entry found.

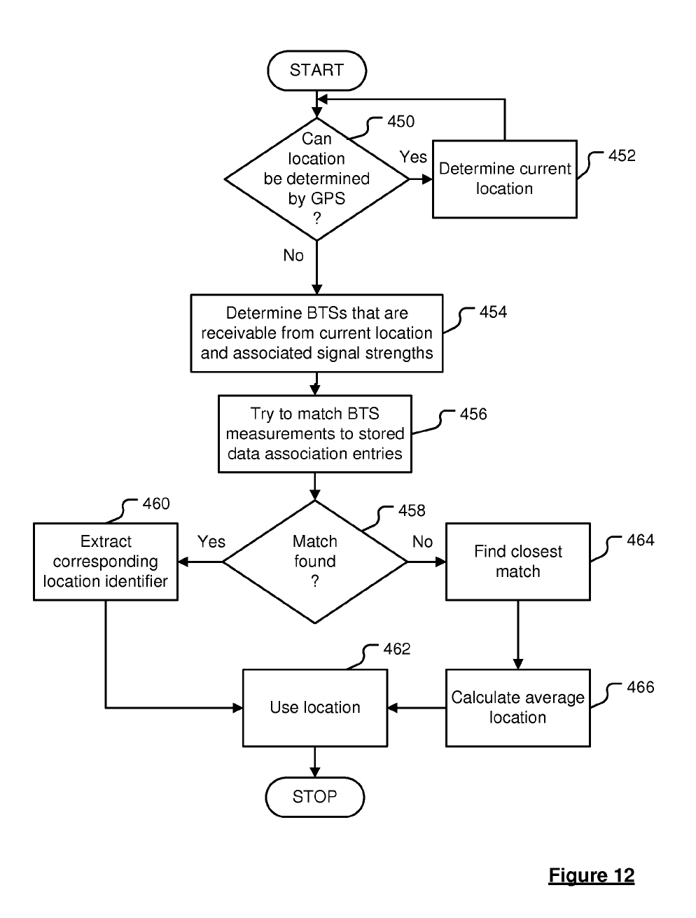

In the event that the exact match cannot be found, the location determination module 268 attempts to find a closest match (Step 434). In this respect, in order to attempt to find the closest match a score, constituting a measure of degree of match, is calculated for each data association entry of the BTS-coordinate database. Referring to FIG. 11, the location determination module 268 scans (Step 436) through each data association entry of the BTS-coordinate database and, for each data association entry also scans through each BTS entry and where a BTS is identified that has also been identified by the GSM communications module 228, a point is attributed (Step 438) to the data association entry. Indeed, for each BTS identity listed in respect of the data association entry, and identified by the GSM communications module 228, a point is attributed to the data association entry and a cumulative score is maintained for the data association entry.

Once the scoring has been performed by the location determination module 268 in respect of each data association entry, the location determination module 268 identifies (Step 440) the data association entry having the highest score attributed thereto. Referring back to FIG. 10, once the highest scoring data association entry has been found, the location determination module 268 extracts (Step 442) the coordinate data from the data association entry found to have the highest score and uses (Step 432) the location identifier, in this example the location coordinates, as the current location that can be used, for example, for one or more navigation-related functions.

Hence, the location determination module 268 has again determined the current location, which is associated with the stored number of BTS identities of the data association entry found.

Turning to FIG. 12, in another embodiment, the BTS-coordinate database comprises a plurality of data association entries, each comprising signal strength range data of the type mentioned above.

As in the previous embodiment, the navigation apparatus 200 initially determines (Step 450) whether the current location can be determined by use of GPS capabilities and if this is possible, the navigation apparatus 200 determines (Step 452) the current location by GPS data, for example to be used in relation to navigation.

However, in the event that the navigation apparatus 200 is unable to determine the current location by GPS data, the location determination module 268 of the navigation apparatus 200 determines (Step 454) the identities of a number of the BTSs in the GSM network 228 that are receivable from the current location along with associated respective measured signal strengths. This information is acquired by the GSM communications module 228 in the manner already described above in relation to previous embodiments and so, for the sake of clarity and conciseness of description, will not be described further in relation to this embodiment.

The location determination module 268 then accesses the BTS-coordinate database in order to attempt to match the respective signal strengths of the receivable BTSs at the current location with one of the stored number of signal strength ranges of BTSs in the GSM network 228 associated with a location identifier where the BTSs associated with the stored number of identities of BTSs are known to be receivable. In this respect, the location determination module 268 attempts to find one of the data association entries in the BTS-coordinate database having BTS signal strength ranges that respectively bound the signal strengths, measured by the GSM communications module 228, in respect of the same BTSs identified by the GSM communications module 228. For example, in the event the navigation apparatus 200 is located as shown in FIG. 6, where the first, second and third BTSs 282, 286, 290 are receivable from the current location, the data association entry in the BTS-coordinate database that needs to be found must have associated signal strength ranges that bound the signal strengths correspondingly measures in respect of the first, second and third BTSs 282, 286, 290, i.e. BTS identities must match and the signal strengths coincide.

The location determination module 268 therefore determines (Step 458) whether a match has been found. In the event that an exact match has been found, i.e. a data association entry has been found having signal strength ranges that bound signal strengths of the same BTSs identifiable by the GSM communications module 228, the location determination module 268 extracts (Step 460) the coordinate data from the data association entry found to be the exact match and uses (Step 462) the location identifier, in this example the location coordinates, as the current location that can be used, for example, for navigation-related functions.

Hence, the location determination module 268 has determined the current location, which is associated with the stored number of BTS identities of the data association entry found.

In the event that the exact match cannot be found, location determination module 268 attempts to find a closest match (Step 464). In this respect, in order to attempt to find the closest match a score, constituting a measure of degree of match, is calculated for each data association entry of the BTS-coordinate database in the following manner. Turning again to FIG. 11, the location determination module 268 scans (Step 436) through each data association entry of the BTS-coordinate database and, for each data association entry also scans through each BTS entry and where a BTS is identified that has also been identified by the GSM communications module 228 and the signal strength range associated with the BTS identified bounds the corresponding signal strength measured by the GSM communications module 228 in respect of the BTS identified, a point is attributed (Step 438) to the data association entry. Indeed, for each BTS identity listed in respect of the data association entry that has also been identified by the GSM communications module 228 and has a respective signal strength range that bounds the corresponding signal strength measured by the GSM communications module 228, a point is attributed to the data association entry and a cumulative score is maintained for the data association entry.

Once the scoring has been performed by the location determination module 268, in one embodiment, the location determination module identifies (Step 440) the data association entry having the highest score attributed thereto and the location determination module 268 extracts the coordinate data from the data association entry found to have the highest score and uses the location identifier, in this example the location coordinates, as the current location that can be used, for example, for one or more navigation-related functions.

In another embodiment, the location determination module 268, instead of selecting a single highest score, selects a number of highest scoring data association entries, for example the highest three scoring data association entries. Turning back to FIG. 12, the location determination module 268 extracts the coordinate data from the data association entries selected and calculates an average location from the coordinate data extracted, for example an intersecting location between the coordinates of the three locations selected. The calculated location is then used (Step 462) as the current location that can be used, for example, for one or more navigation-related functions. The same methodology of selecting a number of highest scoring entries can be applied in relation to the data association entries of the previous embodiment where signal strength data is not used.

Hence, the location determination module 268 has again determined the current location, which is associated with the stored number of BTS identities of the data association entry found.

It should be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, although the above examples have been described in the context of a second generation communications network, namely the GSM network 228, the skilled person should appreciate that the above technique can be employed in relation to a third generation communications network, for example a Universal Mobile Telecommunications System (UMTS) network. In this respect, the GSM communication module is replaced by a UMTS communications module capable of behaving as a User Equipment (UE) unit. In common with the GSM network, signal strengths can be measured in respect of a given Node B in the UMTS communications network by measuring, for example, in respect of the primary common pilot channel used by the Node B or, for example, as described in U.S. Pat. No. 7,324,497.

In the light of the applicability of the above embodiments to other communications systems, the skilled person should appreciate that the term “base station” should not be construed narrowly and should be understood as embracing, for example Node Bs.

Whilst embodiments described in the foregoing detailed description refer to GPS, it should be noted that the navigation apparatus may utilise any kind of position sensing technology as an alternative to (or indeed in addition to) GPS. For example the navigation apparatus may utilise using other global navigation satellite systems such as the European Galileo system. Equally, it is not limited to satellite based but could readily function using ground based beacons or any other kind of system that enables the device to determine its geographic location.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

It will also be well understood by persons of ordinary skill in the art that whilst the preferred embodiment implements certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

1. A navigation apparatus comprising:
a wireless communications unit for data communication via a wireless communications network supported by identifiable base stations;
a processing resource arranged to support, when in use, an operational environment, the operational environment supporting a location determination module arranged to receive from the wireless communications unit and at a current location at least identities of a number of the identifiable base stations receivable by the wireless communications unit; wherein the location determination module is capable of accessing a data store comprising a plurality of data association entries, each data association entry comprising a stored number of identities of the identifiable base stations and a location identifier associated with a location where the stored number of identities are receivable; and
the location determination module is arranged to determine from the plurality of data association entries the current location associated with the stored number of identities.

2. An apparatus as claimed in claim 1, further comprising:
a location-determination signal receiver; wherein
the operational environment supports another location determination module capable of determining the current location based upon wireless location-determination signals when received by the location determination signal receiver.

3. An apparatus as claimed in claim 1, wherein the location determination module is arranged to attempt to match the identities of the number of the identifiable base stations respectively with the stored number of identities of the identifiable base stations of a data association entry of the plurality of data association entries, the location identifier associated with the stored number of identities of the identifiable base stations also substantially identifying the current location when the match occurs.

4. An apparatus as claimed in claim 3, wherein the match is a best match.

5. An apparatus as claimed in claim 4, wherein the location determination module is arranged to measure a respective degree of match in respect of each of a number of the plurality of data association entries by calculating a respective score in respect of match between the identities of the number of identifiable base stations and the stored number of identities of the identifiable base stations of the each of the number of the plurality of data association entries.

6. An apparatus as claimed in claim 5, wherein for each of the number of the plurality of data association entries, the respective score is indicative of a quantity of matching identities of the receivable number of identities with the corresponding stored number of identities of the identifiable base stations.

7. An apparatus as claimed in claim 1, wherein the location determination module is arranged also to receive from the wireless communications unit a number of signal strength measurements in respect of the current location and respectively associated with the receivable number of identities.

8. An apparatus as claimed in claim 1, wherein the each data association entry also comprises a number of signal strength ranges respectively associated with the stored number of identities of the identifiable base stations.

9. An apparatus as claimed in claim 8, when dependent upon claim 7, wherein the location determination module is arranged to attempt to find a match by finding a data association entry of the plurality of data association entries having as many as possible of the number of signal strength ranges thereof bounding respective signal strength measurements of the number of signal strength measurements.

10. An apparatus as claimed in claim 9, wherein more than one of the plurality of data association entries constitute best matches in respect of the number of signal strength measurements.

11. An apparatus as claimed in claim 10, wherein the location determination module is arranged to calculate the current location from the location identifiers of the more than one data association entries.

12. An apparatus as claimed in claim 11, wherein the location determination module is arranged to calculate a substantially average location from locations associated with the location identifiers.

13. An apparatus as claimed in claim 9, wherein the match is a best match.

14. An apparatus as claimed in claim 10, wherein the location determination module is arranged to measure a respective degree of match in respect of the data association entry by calculating a score in respect of the number of signal strength ranges bounding the respective signal strength measurements of the number of signal strength measurements, a respective score being calculated for each of the plurality of data association entries.

15. An apparatus as claimed in claim 6, wherein a highest score is indicative of the best match, the location determination module being arranged to find the highest score.

16. An apparatus as claimed in claim 1, wherein the wireless communications network is a cellular communications network.

17. An apparatus as claimed in claim 1, wherein the at least identities are at least cell identities (IDs) respectively associated with the number of the identifiable base stations.

18. A location determination system comprising:
a navigation apparatus as claimed in claim 1;
a server apparatus comprising the data store; wherein the navigation apparatus is arranged to send a request to the server apparatus in order to access the plurality of data association entries.

19. A method of location determination, the method comprising:
receiving from a wireless communications and at a current location at least identities of a number of the identifiable base stations receivable by the wireless communications unit;
accessing a data store comprising a plurality of data association entries, each data association entry comprising a stored number of identities of the identifiable base stations and a location identifier associated with a location where the stored number of identities are receivable; and
determining from the plurality of data association entries the current location associated with the stored number of identities.

20. A method of navigation in the absence of sufficient satellite-broadcast location-related information comprising the method as claimed in claim 19.

21. A computer program element comprising computer program code to make a computer execute the method as claimed in claim 19.

22. A computer program element as claimed in claim 21, embodied on a non-transitory computer readable medium.
